(19) United States
(12) Patent Application Publication
(10) Pub. No.: US 2013/0268385 A1
(43) Pub. Date: Oct. 10, 2013

(54) GROUP-BUYING SYSTEM AND METHOD THEREOF

(71) Applicant: DADNY INC., Taipei City (TW)

(72) Inventor: DANIEL SHIH, Taipei City (TW)

(73) Assignee: DADNY INC., Taipei City (TW)

(21) Appl. No.: 13/665,768

(22) Filed: Oct. 31, 2012

(30) Foreign Application Priority Data
Apr. 5, 2012 (TW) 101112069

(51) Int. Cl. G06Q 30/00

(52) U.S. Cl. 705/26.2

(57) ABSTRACT

This invention discloses a group-buying system and a method thereof. The system comprises a server end and a plurality of user ends. The system server provides a group-buying platform. The plurality of user ends is connected to the server end so as to log onto the group-buying platform. Wherein, user ends can create a group-buying message related to a specific product and display the group-buying message on the group-buying platform so as to launch a group-buying activity for the specific product. The group-buying message comprises a buyer number threshold value defining the minimum number of people which the group-buying activity needs. The server executes a trading procedure with each of the user ends joining the group-buying activity, when the number of people joining the group-buying activity is greater than or equal to the buyer number threshold value.

### CROSS-REFERENCE TO RELATED APPLICATION

This application claims the benefit of Taiwan Patent Application No. 101112069, filed on Apr. 5, 2012, in the Taiwan Intellectual Property Office, the disclosure of which is incorporated herein in its entirety by reference.

### BACKGROUND OF THE INVENTION

1. Field of the Invention

The present invention generally relates to a group-buying system and a method thereof, in particular to a group-buying system and method for providing a shopping platform for the users to create a group-buying message according to their own needs.

2. Description of the Related Art

With the development of the Internet, E-Commerce has become an important part of the modern living. Thus, more and more people get used to purchase products via the Internet. Nowadays, there are several types of on-line shoppings, such as the on-line auction, the on-line group-buying and the like. Since the on-line group-buying can not only provide lower product price, but also better product quality than the on-line auction, the on-line group-buying gets most of the attention of the modern people.

However, most of the conventional group-buying websites can only provide a shopping platform and certain of products for the users. The categories and number of the product provided by the conventional group-buying websites are limited to few product providers. Accordingly, the user can just purchase the products shown in the conventional group-buying websites. On the other hand, the price breaks for the products are determined in advance by product providers of the conventional group-buying websites. Therefore, the users cannot bargain for a lower price by themselves.

Accordingly, the primary object of the present invention is to provide a more convenient group-buying system which allows the users to purchase any desired product and bargain for a lower price for themselves.

### SUMMARY OF THE INVENTION

To achieve the foregoing objective, the present invention provides a group-buying system. The system comprises a server end and a plurality of user ends. The server end provides a shopping platform. The user ends are connected to the server end to log onto the shopping platform. Wherein, the user ends are able to create at least one group-buying message related to a specific product for the other user ends to choose therefrom in order to launch a group-buying activity for purchasing the specific product; the group-buying message comprises a buyer number threshold value; when a number of the user ends participating in the group-buying activity is equal to or greater than the buyer number threshold value, the server end performs a transaction process for each of the user ends participating in the group-buying activity.

To achieve the foregoing objective, the present invention further provides a group-buying method. The method comprises the following steps of: connecting a plurality of user ends to the server end for the user ends to log onto the shopping platform; creating at least one group-buying message related to any specific product by any of the user ends for the other user ends to choose therefrom in order to launch a group-buying activity for purchasing the specific product, wherein the group-buying message comprises a buyer number threshold value; and performing a transaction process for each of the user ends participating in the group-buying activity by the server end when a number of the user ends participating in the group-buying activity is equal to or greater than the buyer number threshold value.

Preferably, the group-buying message further comprises a group-buying price and an original price.

Preferably, the group-buying price is created by the user end who created the group-buying message or provided by the server end.

Preferably, when the number of the user ends participating in the group-buying activity is equal to or greater than the buyer number threshold value, the server end performs the transaction process for each of the user ends participating in the group-buying activity according to the group-buying price.

Preferably, when the number of the user ends participating in the group-buying activity is lower than the buyer number threshold value, the server end performs the transaction process for each of the user ends participating in the group-buying activity with the original price.

Preferably, the group-buying message further comprises an option for the user ends participating in the group-buying activity to determine whether or not to accept that the serve end performs the transaction process with the original price when the number of the user ends participating in the group-buying activity fails to reach the buyer number threshold value.

Preferably, the server end determines the group-buying price according to the buyer number threshold value.

The group-buying system and the method thereof may have one or more of the following advantages:

(1) The group-buying system and the method thereof can provide the user with a shopping platform. Any of the users may create a group-buying message related to a specific product on the shopping platform according to their needs to recruit group-buying members so as to get a price break for the specific product. Also, since the present invention allows the users to create the group-buying message to launch a group-buying activity for purchasing any specific product, the user ends can choose whatever they want, which resolves the conventional group-buying system's problem.

(2) The group-buying system and the method thereof can provide a shopping platform for any of the users to launch a group-buying activity to recruit group-buying members in order to purchase a specific product. Accordingly, the price of the specific product may reduce with the increase of the number of the group-buying members, which provides an opportunity for the user to purchase the specific product for a knockdown price.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is the block diagram of the group-buying system in accordance with the present invention.

FIG. 2 is the block diagram of the first preferred embodiment of the group-buying system in accordance with the present invention.

FIG. 3 is the flow chart of the first preferred embodiment of the group-buying system in accordance with the present invention.

FIG. 4 is the schematic view of the second preferred embodiment of the group-buying system in accordance with the present invention.

FIG. 5 is the flow chart of the second preferred embodiment of the group-buying system in accordance with the present invention.

FIG. 6 is the flow chart of the group-buying method in accordance with the present invention.

### DETAILED DESCRIPTION OF THE PREFERRED EMBODIMENTS

The technical content of the present invention will become clear by the detailed description of the following embodiments and the illustration of related drawings as follows.

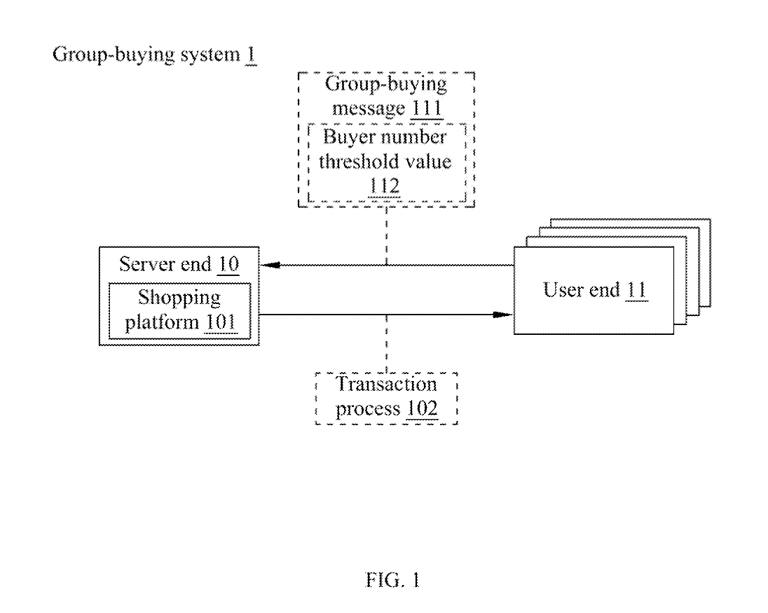

With reference to FIG. 1 for the block diagram of the group-buying system in accordance with the present invention. As shown in FIG. 1, the group-buying system comprises the server end 10 and the plurality of the user ends 11. The shopping platform 101 is provided by the server end 10. The plurality of the user ends 11 are connected to the server end 10 to log onto the shopping platform 101. Wherein, the user end 11 can be a mobile communication device, a personal computer or any electronic device with communication function. Any of the user ends 11 may create at least one group-buying message 111 related to any specific product for the other user ends 11 to choose therefrom in order to purchase the specific product. In addition, the group-buying message 111 may comprise the buyer number threshold value 112. When the number of the user ends 11 participating in the group-buying activity 111 is equal to or greater than the buyer number threshold value 112, the server end 10 may perform the transaction process 102 for each of the user ends 11 participating in the group-buying message 111. Briefly speaking, each of the user ends 11 can create the group-buying message 111 related to a specific product via the shopping platform 101 to launch a group-buying activity for purchasing the specific product. Accordingly, the group-buying system 1 may allow the user ends 11 to launch a group-buying activity for any product which they want to purchase according to their own needs even if the product fails to be displayed on the shopping platform 101, which can resolve the problem that the user can merely purchase certain of products shown in the conventional group-buying websites.

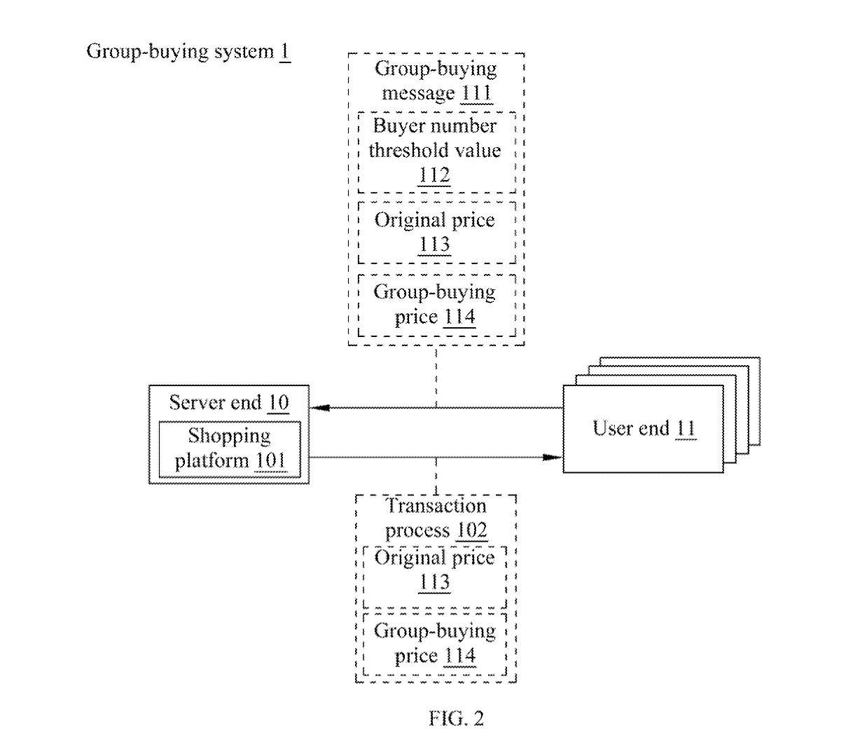

With reference to FIG. 2 for the block diagram of the first preferred embodiment of the group-buying system in accordance with the present invention. As shown in FIG. 2, the group-buying system 1 comprises the server end 10 and the plurality of user ends 11. The shopping platform 101 is provided by the server end 10. The user ends 11 are connected to the server end 10 to log onto the shopping platform 101. Wherein, a verification mechanism can be provided by the server end 10 to verify the user ends' 11 access to the shopping platform 101, such that the server end 10 can obtain the member information of each of the user ends 11 which have signed in the shopping platform 101. After signing in the shopping platform 101, any of the user ends 11 may create a group-buying message 111 to launch a group-buying activity so as to purchase a specific product and the group-buying message 111 may be stored in the database 103. The group-buying message 111 may comprise the buyer number threshold value 112, the group-buying price 113 and the original price 114. After connected to the server end 11 and then signing in the shopping platform 101, any of the user ends 11 can browse the group-buying messages 111 displayed on the shopping platform 101, and choose any of the group-buying messages 111, and then join the group-buying activity thereof so as to purchase a specific product. When the number of the user ends 11 participating in the group-buying activity reaches the buyer number threshold value 112, the server end 10 executes the transaction process 102 with the user ends which join the group-buying activity with the group-buying price 113 shown in the group-buying message 111. Moreover, in actual application, when the user ends 11 participate in the group-buying activity, an option may be provided for the user ends 11 to determine whether or not to purchase the specific product for the original price 114 if the number of the user ends 11 participating in the group-buying activity fails to reach the buyer number threshold value 112.

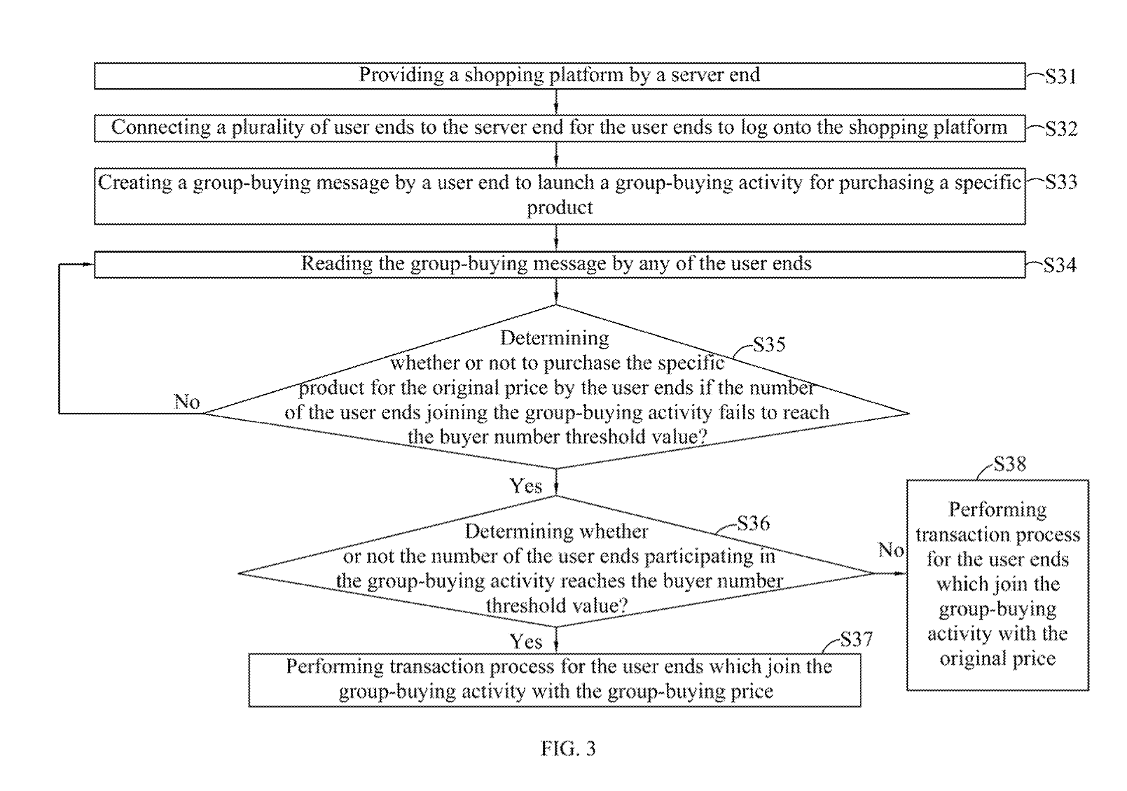

With reference to FIG. 3 for the flow chart of the first preferred embodiment of the group-buying system in accordance with the present invention.

S31: providing a shopping platform by a server end;

S32: connecting a plurality of user ends to the server end for the user ends to log onto the shopping platform;

S33: creating a group-buying message by a user end to launch a group-buying activity for purchasing a specific product;

S34: reading the group-buying message by any of the user ends;

S35: determining whether or not to purchase the specific product for the original price by the user ends if the number of the user ends joining the group-buying activity fails to reach the buyer number threshold value;

S36: determining whether or not the number of the user ends participating in the group-buying activity reaches the buyer number threshold value;

S37: performing transaction process for the user ends which join the group-buying activity with the group-buying price; and

S38: performing transaction process for the user ends which join the group-buying activity with the original price.

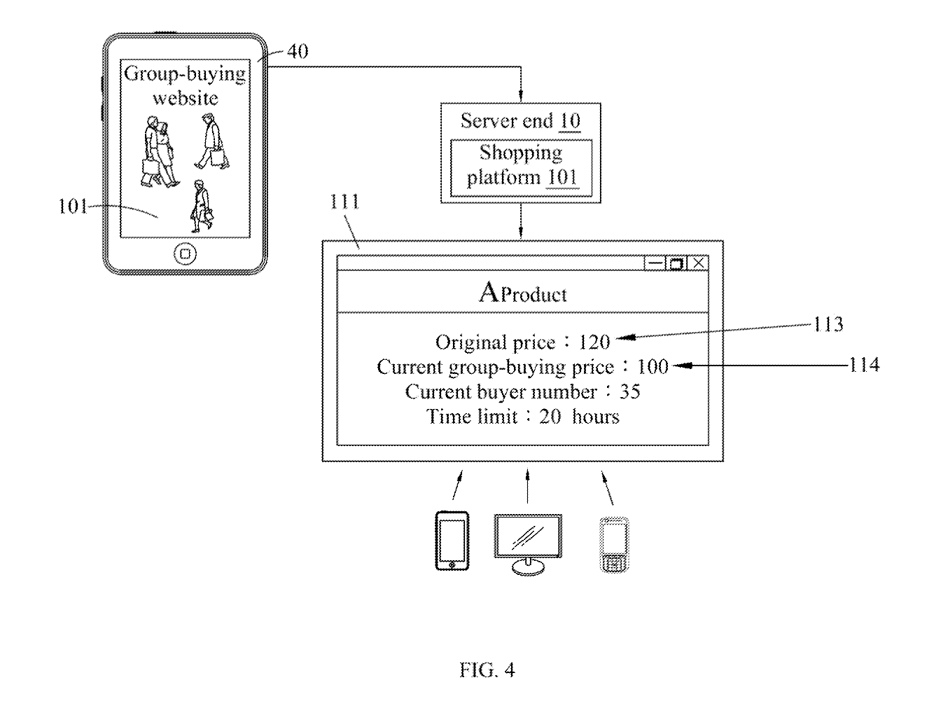

With reference to FIG. 4 for the schematic view of the second preferred embodiment of the group-buying system in accordance with the present invention. As shown in FIG. 4, the group-buying system 1 comprises the server end 10 and the plurality of the user ends 11. The shopping platform 101 is provided by the server end 10. The user ends 11 are connected to the server end 10 to log onto the shopping platform 101. After signing in the shopping platform 101, any of the user ends 11 can create at least one group-buying message 111 to purchase a specific product, wherein the group-buying message 111 may comprise the original price 114. After the group-buying messages 111 have been created, any of the user ends 11 can log onto the shopping platform 101 to choose any of the group-buying messages 111 to join. The server end 10 can provide the group-buying price 104 according to the number of the user ends 11 joining the group-buying message 111. Furthermore, the server end 10 can set time limit for the group-buying message 111.

That is to say, the mobile communication device 40 (one of the user ends 11) can log onto the shopping platform 101 to create the group-buying message 111 so as to purchase a specific product, wherein the group-buying message 111 may comprise the original price 114 of the specific product. The other user ends 11 (which may be a mobile communication device, a personal computer or any electronic device with communication function) can be connected to the server end 10 and then log onto the shopping platform 101 in order to read the group-buying messages 111 and choose one of which to join. Wherein, the group-buying message 111 may comprise the group-buying price 114, and the group-buying price 114 may vary with the number of people joining the group-buying message 111. That is to say, the group-buying price 114 may reduce with the increase of the number of people joining the group-buying activity launched by the group-buying message 111, such that the users may purchase the specific product for a lower price when more people participate in the group-buying activity. With this mechanism, the user can have the opportunity to purchase the desired product for a lower price and the group-buying activity can become more interesting to the users. Furthermore, in actual application, the group-buying message 111 may further comprise the time limit. That is to say, the user ends 11 participating in the group-buying activity launched by the group-buying message 111 have to purchase the specific product for the group-buying price 114 corresponding to the number of the user ends 11 participating in the group-buying activity within the time limit. In addition, when the user ends 11 joining the group-buying activity reaches a certain number, the server end 10 may ask the product provider to provide the group-buying price 114 corresponding to the number for these user ends 11 to determine whether or not to purchase the specific product for this price. However, the aforementioned is just for example instead of limitation, and the present invention is not limited to such arrangement only.

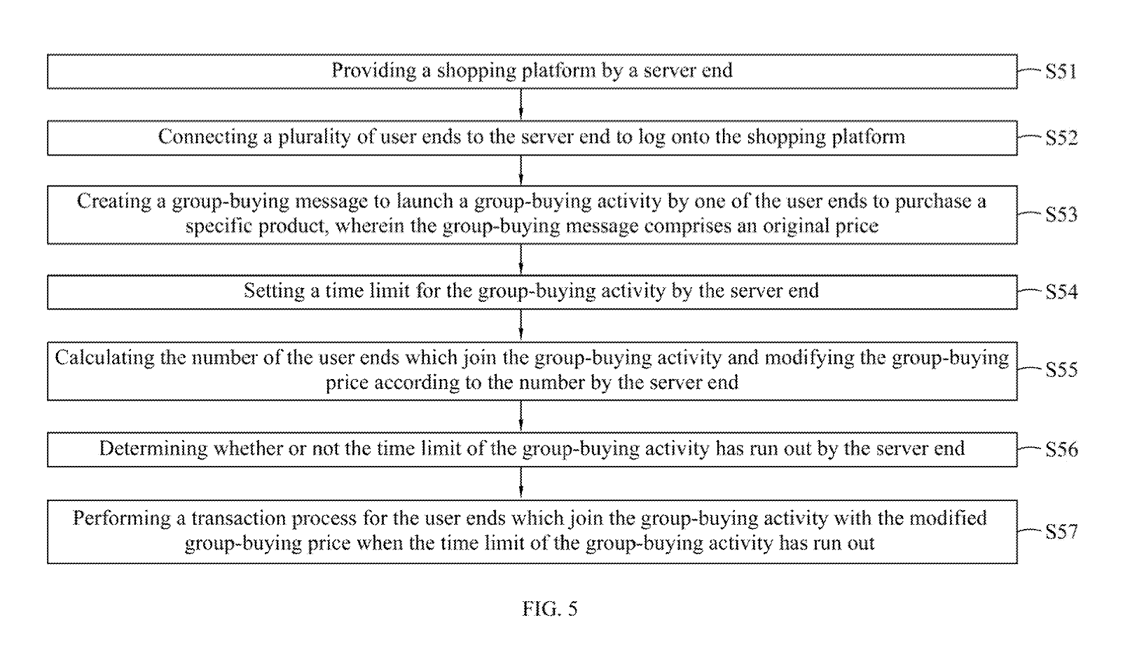

With reference to FIG. 5 for the flow chart of the second preferred embodiment of the group-buying system in accordance with the present invention.

S51: providing a shopping platform by a server end;

S52: connecting a plurality of user ends to the server end to log onto the shopping platform;

S53: creating a group-buying message to launch a group-buying activity by one of the user ends to purchase a specific product, wherein the group-buying message comprises an original price;

S54: setting a time limit for the group-buying activity by the server end;

S55: calculating the number of the user ends which join the group-buying activity and modifying the group-buying price according to the number by the server end;

S56: determining whether or not the time limit of the group-buying activity has run out by the server end; and

S57: performing a transaction process for the user ends which join the group-buying activity with the modified group-buying price when the time limit of the group-buying activity has run out.

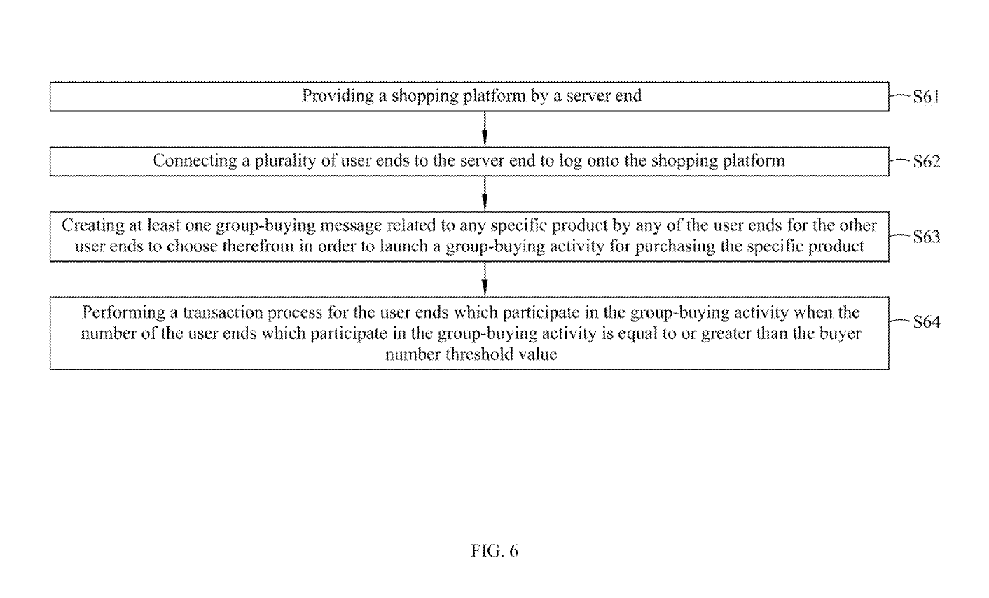

With reference to FIG. 6 for the flow chart of the group-buying method in accordance with the present invention.

S61: providing a shopping platform by a server end;

S62: connecting a plurality of user ends to the server end to log onto the shopping platform;

S63: creating at least one group-buying message related to any specific product by any of the user ends for the other user ends to choose therefrom in order to launch a group-buying activity for purchasing the specific product; and

S64: performing a transaction process for the user ends which participate in the group-buying activity when the number of the user ends which participate in the group-buying activity is equal to or greater than the buyer number threshold value.

The detailed description and exemplary embodiments of the group-buying method according to the present invention have been described in the description of the group-buying system according to the present invention and will not be repeated again.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A group-buying system, comprising;
a server end, arranged for providing a shopping platform; and
a plurality of user ends, connecting to the server end to log onto the shopping platform;
wherein, the user ends is able to create at least one group-buying message related to a specific product for the other user ends to choose therefrom in order to launch a group-buying activity for purchasing the specific product; the group-buying message comprises a buyer number threshold value; when a number of the user ends participating in the group-buying activity is equal to or greater than the buyer number threshold value, the server end performs a transaction process for the user ends participating in the group-buying activity.

2. The group-buying system of claim 1, wherein the group-buying message further comprises a group-buying price and an original price.

3. The group-buying system of claim 2, wherein the group-buying price is edited by the user end who created the group-buying message or provided by the server end.

4. The group-buying system of claim 2, wherein the server end performs the transaction process for the user ends participating in the group-buying activity according to the group-buying price.

5. The group-buying system of claim 2, wherein when the number of the user ends participating in the group-buying message is lower than the buyer number threshold value, the server end performs the transaction process for each of the user ends participating in the group-buying activity with the original price.

6. The group-buying system of claim 5, wherein the group-buying message further comprises an option for the user ends participating in the group-buying message to determine whether or not to accept the transaction process.

7. The group-buying system of claim 1, wherein the server end determines a group-buying price according to the buyer number threshold value.

8. A group-buying method, comprises:
providing a server end arranged for providing a shopping platform;
connecting a plurality of user ends to the server end for the user ends to log onto in the shopping platform;
creating at least one group-buying message related to any specific product by any of the user ends for the other user ends to choose therefrom in order to launch a group-buying activity for purchasing the specific product, wherein the group-buying message comprises a buyer number threshold value; and
performing a transaction process for each of the user ends participating in the group-buying message by the server end when a number of the user ends participating in the group-buying message is equal to or greater than the buyer number threshold value.

9. The group-buying method of claim 8, wherein the group-buying message further comprises a group-buying price and an original price.

10. The group-buying method of claim 9, wherein the group-buying price is edited by the user end which created the group-buying message or provided by the server end.

11. The group-buying method of claim 9, further comprising the following step of:
performing the transaction process for each of the user ends participating in the group-buying message with the group-buying price by the server end.

12. The group-buying method of claim 9, further comprising the following step of:
performing the transaction process for each of the user ends participating in the group-buying message with the original price by the server end when the number of the user ends participating in the group-buying message is lower than the buyer number threshold value.

13. The group-buying system of claim 9, wherein the group-buying message further comprises an option for the user ends participating in the group-buying message to determine whether or not to accept the transaction process.

14. The group-buying method of claim 8, wherein the server end determines a group-buying price according to the buyer number threshold value.
